(19) United States
(12) Patent Application Publication
(10) Pub. No.: US 2007/0244577 A1
(43) Pub. Date: Oct. 18, 2007

(54) Device assisted wizard

(76) Inventors: Edward K. Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US); Lowell L. Wood JR., Livermore, CA (US)

Correspondence Address: ANDERSON LAW GROUP, PLLC, 9600 GREAT HILLS TRAIL, 150W, AUSTIN, TX, 78759, US

(21) Appl. No.: 11/406,047

(22) Filed: Apr. 18, 2006

(51) Int. Cl. G05B 19/18

(52) U.S. Cl. 700/60

(57) ABSTRACT

A method and physician tool for providing medical diagnostic assistance includes but is not limited to a method including receiving two or more health-related parameters of a living entity, applying one or more algorithms to the two or more health-related parameters to generate one or more diagnostic possibilities with associated statistical likelihood, and producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options.

### TECHNICAL FIELD

The present application relates generally to medical diagnostic assistance wizards.

### SUMMARY

In one aspect, a method for providing medical diagnostic assistance includes but is not limited to receiving two or more health-related parameters of a living entity; applying one or more algorithms to the two or more health-related parameters to generate one or more diagnostic possibilities with associated statistical likelihood; and producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options. In addition to the foregoing, other method aspects are described in the claims, drawings, and text forming a part of the present application.

In another aspect, a computer program product includes but is not limited to a signal bearing medium bearing at least one of one or more instructions for receiving two or more health-related parameters of a living entity; one or more instructions for applying one or more algorithms to the two or more health-related parameters to generate one or more diagnostic possibilities with associated statistical likelihood; and one or more instructions for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options. In addition to the foregoing, other computer program product aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In one aspect, a physician tool includes but is not limited to a processor, a, memory coupled to the processor, a database coupled to the processor, the database configured to store symptom data and diagnostic criteria correlated to the symptom data; and a diagnostic module coupled to the processor, the diagnostic module configured to include: an entry module for receiving two or more health-related parameters of a living entity, and an algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood, and an output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options. In addition to the foregoing, other physician tool aspects are described in the claims, drawings, and text forming a part of the present application.

In addition to the foregoing, various other method, system, computer program product, and/or physician tool aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a block diagram of a physician tool that supports the claimed subject matter of the present application; and

FIGS. 3A and 3B illustrate a flow diagram of a method in accordance with an embodiment of the subject matter of the present application.

### DETAILED DESCRIPTION OF THE DRAWINGS

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

The disclosures provided herein relate to a device-assisted wizard for assisting physicians, medical personnel, insurance companies, emergency room care givers, veterinarians and the like in providing objective diagnoses and treatment options for living entities, such as human patients, animals and other entities requiring diagnosis and/or treatment options. More particularly, physician malpractice has been increasingly troublesome for physicians, medical personnel, hospital, insurers and the like. Patient confidence with physicians is eroding due to the wide variety of diagnoses a patient can receive. Although the practice of medicine can vary from doctor's office to doctor's office, a frequent problem encountered by patients is that the same set of symptoms, history and circumstances seen by two or more physicians can produce drastically different diagnoses and treatment plans. Thus, a same patient seen by two physicians can independently receive different medications, lab orders, diagnoses and the like. The differences in patient care and mistakes made by physicians have caused insurance companies to raise premiums for malpractice insurance and some states to impose tort reform laws that limit the liability of doctors for medical malpractice. As a result, patients have little or no recourse for diagnostic errors and treatment mistakes. The physician tool described herein provides an objective tool to prevent mistakes made by physicians and limit physician liability exposure by providing patients with objective options for diagnosis and treatment. The physician tool provides a patient with objective data to allow patients and/or representatives of a patient to make an informed choice as to treatment and care. The physician tool can produce a statistical report that can be viewed directly by a patient or disclosed in a number of ways via a graphical user interface or the like. Thus, disclosures herein provide a device-assisted wizard displayable via a user interface that is capable of limiting liability by avoiding placing physicians in the position of having to provide binary decisions to patients. Instead, a statistical report can be provided to patients which includes a statistical hierarchy of potential diagnoses, treatment options, laboratory test options and the like.

In one embodiment, as described in further detail below, the physician tool can be used in emergency room scenarios and can be used by nurses, physicians, physician's assistants, and the like. In operation, the physician's tool can be used to enable a physician or other health care worker to provide objective criteria for assisting a patient make a decision regarding their care, including different possibilities and statistical likelihoods supporting the different possibilities, including statistical distributions of likelihood of diagnosis and treatment options. The statistical information can be presented to a patient or representative of a patient in the form of a differential diagnosis.

In one or more embodiments, the physician's tool can be implemented by a computing system. The computing system can be networked or otherwise coupled to a source of data, such as via a connection to a database to acquire data necessary for implementing embodiments disclosed herein.

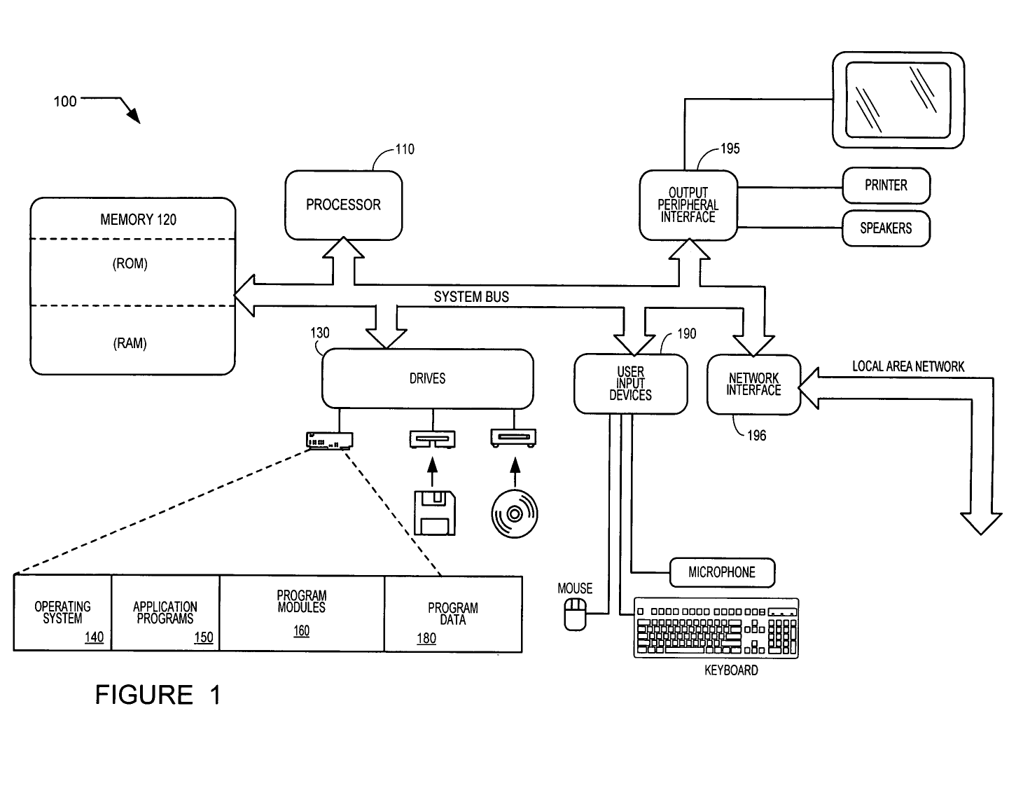

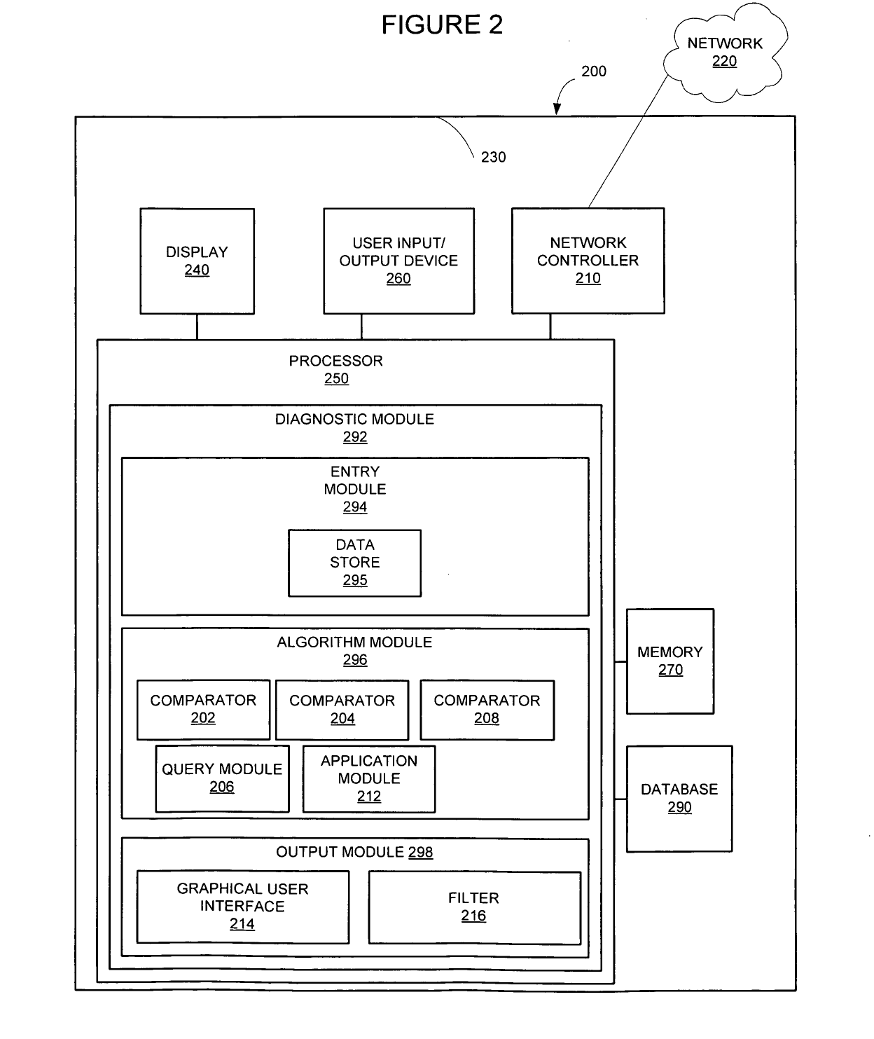

With reference to FIG. 1, depicted is an exemplary computing system for implementing embodiments. FIG. 1 includes a computer 100, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, which can include a diagnostic module 292 depicted in FIG. 2, and program data 180. Computer 100 further includes user input devices 190 through which a user may enter commands and data. Input devices can include an electronic digitizer, a microphone, a keyboard and pointing device, commonly referred to as a mouse, trackball or touch pad. Other input devices may include a joystick, a game pad, a satellite dish, a scanner, or the like.

These and other input devices can be connected to processor 110 through a user input interface that is coupled to a system bus, but may be connected by other interface and bus structures, such as a parallel port, a game port or a universal serial bus (USB). Computers such as computer 100 may also include other peripheral output devices such as speakers, which may be connected through an output peripheral interface 195 or the like. More particularly, output devices can include personal digital assistant type devices networked to computer 100 to enable on-the-fly diagnostic assistance.

Computer 100 may operate in a networked environment using logical connections to one or more computers, such as a remote computer connected to network interface 196 The remote computer may be a personal computer, a server, a router, a network PC, a peer device or other common network node, and can include many or all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN, such as the Internet. It will be appreciated that other means of establishing a communications link between the computers may be used.

Referring now to FIG. 2, illustrated is an exemplary block diagram of a physician's tool 200, which can be implemented as a computer system, such as computer system 100, a personal digital assistant or any processor-enabled system. Physician's tool 200 can optionally include a network controller 210 which can be coupled to network 220. Network 220 may include a data network, such as the Internet, an intranet, a local area network (LAN), a wide area network (WAN), a cable network, and other like communication systems. Network 220 may also include a telecommunications network, such as a local telephone network, a long distance telephone network, a cellular telephone network, a satellite communications network, a cable television network and other like communications systems that interact with computer systems. Network 220 may include more than one network and may include a plurality of different types of networks.

Physician's tool 200 can include a housing 230, processor 250, a display 240 coupled to processor 250, a user input/output device 260 coupled to processor 250, a memory 270, the memory coupled to the processor 250. Physician's tool 200 is shown including a database 290 that can be a database coupled to the processor, the database configured to store symptom data and diagnostic criteria correlated to the symptom data. According to an embodiment, memory 270 can include a random access memory, a read only memory, an optical memory, a subscriber identity module memory, or any other memory that can be coupled to a communication device. Display 240 can be a liquid crystal display (LCD), a light emitting diode (LED) display, a plasma display, or any other means for enabling access of information. User input/output device 260 can include a keypad, buttons, a touch pad, a joystick, an additional display, or any other device useful for providing an interface between a user and an electronic device.

Physician's tool 200 further includes a diagnostic module 292, diagnostic module 292 can be coupled to processor 250, located within the processor, and/or located in memory 270, the diagnostic module coupled to the processor, the diagnostic module configured to include an entry module 294, the entry module for receiving two or more health-related parameters of a living entity. In one embodiment entry module 294 includes data store 295, which can be configured for receiving one or more of symptom data, one or more physical status parameters, one or more recorded observations, one or more environmental parameters, laboratory data, and a health history specific to the living entity. Entry module 294 can further include one or more means for receiving statistical data related to the living entity wherein the statistical data includes past diagnostic possibility data, and/or for receiving the two or more health-related parameters including subjective criteria from one or more of the living entity and/or a representative of the living entity and/or a physician and/or an indirect source of subjective criteria, and/or for receiving the two or more health-related parameters via a network connection to one or more sources of health-related data including one or more of insurance data sources, physician data sources, veterinary medicine data sources, online medical information sources, and hospital data sources. For example, entry module 294 can receive the statistical data, symptom data and the like. The entry module 294 can be coupled to either a network connection and/or to a user input device.

Diagnostic module 292 further includes an algorithm module 296. Algorithm module 296 can be configured as an algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood. The algorithm module can receive data from the entry module 294 and/or from a user input and/or from a network connection. In one embodiment, algorithm module 296 includes means for applying the one or more algorithms to assess a likelihood for each of the one or more diagnostic possibilities, each of the one or more likelihoods being arranged systematically. More particularly, algorithm module 296 can be coupled to a user input/output device responsive to an indication by a user or other entity to apply the algorithms. The user input/output device can further provide means responsive to user input for arranging by prioritizing a most likely treatment option associated with the one or more diagnostic possibilities, for arranging according to a severity level associated with the one or more treatment options, and for applying a correlation algorithm to correlate one or more objective parameters of the health-related parameters with one or more subjective parameters of the health-related parameters. The user input/output device 260 can provide the means for initiating the arranging the hierarchy and applying the correlation algorithm, however, one of skill in the art will appreciate that algorithm module 296 can also provide internal means by way of code links to self-initiate algorithms, such as the correlation algorithm responsive to initial user input.

In one embodiment, the means for applying a correlation algorithm to correlate one or more objective parameters of the health-related parameters with one or more subjective parameters of the health-related parameters includes a comparator 202 configured for comparing the health-related parameters to the one or more objective parameters via a database including symptom data and correlated diagnostic criteria. Alternatively, or in addition to comparator 202, the means for applying a correlation algorithm to correlate one or more objective parameters of the health-related parameters with one or more subjective parameters of the health-related parameters can include a comparator 204 configured for comparing the health-related parameters to the one or more subjective parameters including one or more subjective perceptions received by the living entity and/or by a representative of the living entity and/or by a physician familiar with the living entity.

In one embodiment, algorithm module 296 includes a query module 206 configured for searching a database of symptom data and correlated diagnostic criteria. For example, query module 206 can be coupled to either a network connection or an internal database, such as database 290 to receive symptom data and correlated diagnostic criteria. Query module 206 can be coupled to comparator 208, which can be configured for comparing the symptom data and the correlated diagnostic criteria with the two or more health-related parameters to find a match. Output from comparator 208 can be provided to application module 212, which can be configured for applying the algorithms to determine the one or more diagnostic possibilities and determine a likelihood of potential diagnoses using the matches, if any, found by comparator 208.

Diagnostic module 292 further includes an output module 298, the output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options. The living entity can be a human, an animal or a plant. Any living entity with a need for diagnostic or treatment options is within the scope of the disclosure.

In one embodiment, output module 298 includes a graphical user interface 214, the graphical user interface configured to produce one or more objective diagnostic options, the graphical user interface configured to illustrate the objective diagnostic options and one or more derivative possibilities from among the one or more objective diagnostic options. In one embodiment, graphical user interface 214 is configured to display a prediction of costs and benefits based on the one or more diagnostic options. Additionally, graphical user interface 214 can include a means for enabling access to the objective diagnostic options as a hierarchical display with one or more differential diagnoses.

In another embodiment, output module 298 includes a filter 216 configured for filtering the one or more diagnostic possibilities organized according to statistical likelihood to produce one or more treatment plans for each diagnostic possibility, each of the one or more treatment plans associated with a diagnosis. Filter 216 can be configured for receiving an input from a healthcare professional, the input providing a limit on the one or more objective diagnostic options available for access by the living entity and/or the representative of the living entity.

Filter 216 can be coupled to graphical user interface 214 enabling access to the one or more treatment plans and associated diagnosis and/or for incorporating insurance coverage data into the cost-benefit analysis and/or for incorporating life expectancy of the living entity into the cost-benefit analysis.

In one embodiment graphical user interface 214 can be configured for receiving an input from a healthcare provider, the input controlling presentation of the one or more diagnostic possibilities available for access by the living entity and/or the representative of the living entity and/or the third party associated with the living entity. For example, the receiving can include receiving the input from the healthcare provider to provide the limit on the number of the one or more diagnostic possibilities based on one or more of a predetermined statistical likelihood for the treatment plan for each diagnostic possibility, and/or a limit based on health-care provider determined elimination.

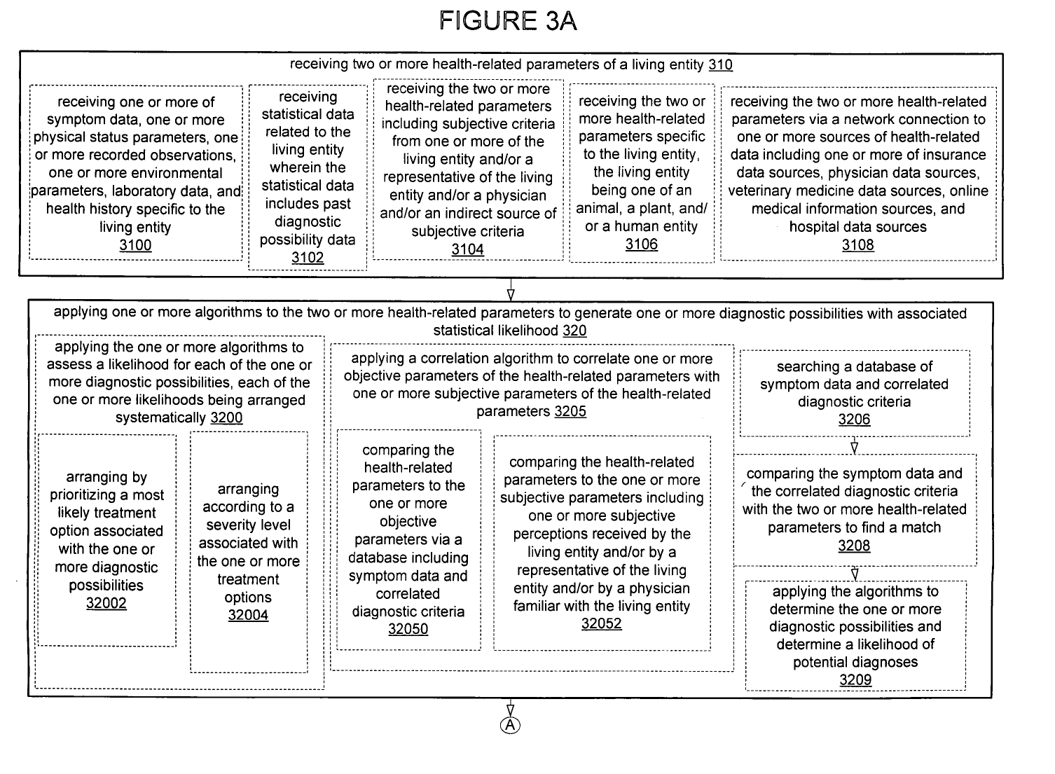

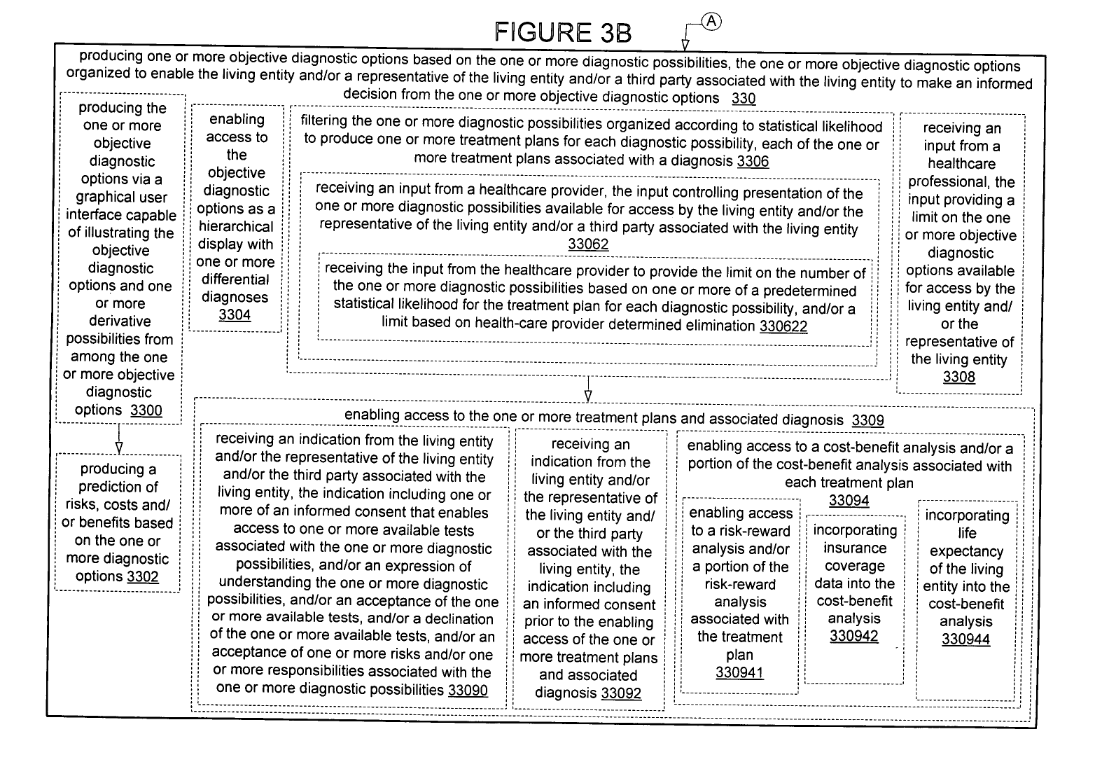

Referring now to FIGS. 3A and 3B, an exemplary flow diagram illustrates the operation of the physician's tool 200.

Block 310 provides for receiving two or more health-related parameters of a living entity (e.g., entry module 294 receiving two or more health-related parameters of a patient or other living entity).

Depicted within block 310 is optional block 3100, which provides for receiving one or more of symptom data, one or more physical status parameters, one or more recorded observations, one or more environmental parameters, laboratory data, and a health history specific to the living entity, (e.g., entry module 294 in cooperation with user input/output device 260 receiving data such as the symptom data, physical status parameters, laboratory data, and health history, and/or entry module 294 receiving data via a network 220).

Further depicted within block 310 is optional block 3102 which provides for receiving statistical data related to the living entity wherein the statistical data includes past diagnostic possibility data, (e.g. entry module 294 receiving diagnostic possibility data from a previous iteration of physician's tool 200 or another diagnostic tool).

Further depicted within block 310 is optional block 3104 which provides for receiving the two or more health-related parameters including subjective criteria from one or more of the living entity and/or a representative of the living entity and/or a physician and/or an indirect source of subjective criteria (e.g., entry module 294 in cooperation with user input/output device 260 receiving data such as health-related parameters including subjective criteria from a patient or representative of a patient or from a physician).

Block 310 also includes optional block 3106 with provides for receiving the two or more health-related parameters specific to the living entity, the living entity being one of an animal, a plant, and/or a human entity (e.g., entry module 294 in cooperation with user input/output device 260 identifying whether the living entity is an animal, plant, human or any type of living entity requiring a diagnosis or treatment).

Block 310 further includes optional block 3108 which provides for receiving the two or more health-related parameters via a network connection to one or more sources of health-related data including one or more of insurance data sources, physician data sources, veterinary medicine data sources, online medical information sources, and hospital data sources (e.g., entry module 294 in cooperation with a network 220 receiving health-related data from a source).

Block 320 provides for applying one or more algorithms to the two or more health-related parameters to generate one or more diagnostic possibilities with associated statistical likelihood (e.g., algorithm module 296 applying algorithms to the two or more health-related parameters).

Depicted within block 320 is optional block 3200 which provides for applying the one or more algorithms to assess a likelihood for each of the one or more diagnostic possibilities, each of the one or more likelihoods being arranged systematically (e.g., algorithm module 296 operating to assess the likelihood of the diagnostic possibilities and arranging the likelihoods into a hierarchy).

Block 3200 includes optional block 32002 which provides that the arranging the hierarchy can include arranging by prioritizing a most likely treatment option associated with the one or more diagnostic possibilities (e.g., algorithm module 296 operating to arrange the hierarchy and listing most likely treatment options associated with the diagnostic possibilities and enabling access of the listing via display 240).

Block 3200 further includes block 32004 which provides for arranging according to a severity level associated with the one or more treatment options (e.g., algorithm module 296 operating to arrange the hierarchy such that more severe diagnoses and treatment options are given priority via display 240).

Block 320 further includes optional block 3205 which provides for applying a correlation algorithm to correlate one or more objective parameters of the health-related parameters with one or more subjective parameters of the health-related parameters (e.g., comparator 202 operating to compare objective parameters with the subjective parameters).

Depicted within block 3205 is shown block 32050 which provides for comparing the health-related parameters to the one or more objective parameters via a database including symptom data and correlated diagnostic criteria (e.g., comparator 204 comparing the health-related parameters after receiving objective parameters via database 290 or a database interacting with physician tool 200 via network 220 in cooperation with network controller 210).

Also depicted within block 3205 is block 32052 which provides for comparing the health-related parameters to the one or more subjective parameters including one or more subjective perceptions received by the living entity and/or by a representative of the living entity and/or by a physician familiar with the living entity (e.g., comparator 204 comparing the health-related parameters after receiving subjective perceptions via either network controller 210 or user input/output device 260).

Block 320 further includes optional blocks 3206, 3208 and 3209. Block 3206 provides that the applying one or more algorithms can include searching a database of symptom data and correlated diagnostic criteria (e.g., query module 206 performing a search of database 290 for symptom data and correlated diagnostic criteria). Block 3208 provides for comparing the symptom data and the correlated diagnostic criteria with the two or more health-related parameters to find a match (e.g. comparator 208 comparing the symptom data and correlated diagnostic criteria to find a match). Block 3209 provides for applying the algorithms to determine the one or more diagnostic possibilities and determine a likelihood of potential diagnoses (e.g., application module 212 receiving the matches found by comparator 208 and determining the diagnostic possibilities and the likelihood of potential diagnoses).

Block 330 provides for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options (e.g., graphical user interface 214 producing the objective diagnostic options).

Block 3300 provides for producing the one or more objective diagnostic options via a graphical user interface capable of illustrating the objective diagnostic options and one or more derivative possibilities from among the one or more objective diagnostic options (e.g., graphical user interface 214 enabling access of via display 240 the objective diagnostic options and derivative possibilities). Following block 3300 is depicted block 3302 which provides for producing a prediction of risks, costs and/or benefits based on the one or more diagnostic options (e.g., graphical user interface 214 producing a prediction of costs and benefits using output from algorithm module 296).

Block 330 further includes optional block 3304 which provides for enabling access to the objective diagnostic options as a hierarchical display with one or more differential diagnoses (e.g., graphical user interface 214 and display 240 enabling access of the objective diagnostic options as a hierarchical display with the differential diagnoses).

Block 330 further includes optional blocks 3306 and 3308. Block 3306 provides for filtering the one or more diagnostic possibilities organized according to statistical likelihood to produce one or more treatment plans for each diagnostic possibility, each of the one or more treatment plans associated with a diagnosis (e.g., filter 216 filtering the one or more diagnostic possibilities). Depicted within block 3306 is optional block 33062 which provides for receiving an input from a healthcare provider, the input controlling presentation of the one or more diagnostic possibilities available for access by the living entity and/or the representative of the living entity and/or the third party associated with the living entity (e.g. filter 216 receiving an input via graphical user interface 214 and user input/output device 260). Depicted within block 33062 is optional block 330622 which provides for receiving the input from the healthcare provider to provide the limit on the number of the one or more diagnostic possibilities based on one or more of a predetermined statistical likelihood for the treatment plan for each diagnostic possibility, and/or a limit based on health-care provider determined elimination (e.g. filter 216 receiving an input via graphical user interface 214 and user input/output device 260).

Further depicted within block 330 is optional block 3308, which provides for receiving an input from a healthcare professional, the input providing a limit on the one or more objective diagnostic options available for access by the living entity and/or the representative of the living entity (e.g., filter 216 receiving an input via graphical user interface 214 and user input/output device 260 operated by a healthcare professional).

Block 3306 is shown in the flow diagram coupled to Block 3309, which provides for enabling access to the one or more treatment plans and associated diagnosis (e.g., display 240 illustrating each treatment plan and associated diagnosis). Within block 3309 is shown optional block 33090, which provides for receiving an indication from the living entity and/or the representative of the living entity and/or the third party associated with the living entity, the indication including one or more of an informed consent that enables access to one or more available tests associated with the one or more diagnostic possibilities, and/or an expression of understanding the one or more diagnostic possibilities, and/or an acceptance of the one or more available tests, and/or a declination of the one or more available tests, and/or an acceptance of one or more risks and/or one or more responsibilities associated with the one or more diagnostic possibilities (e.g., graphical user interface 214 receiving an input via user input/output device 260 including an indication from the living entity and/or the representative of the living entity including an informed consent and/or an acceptance of risk that triggers access to one or more available tests determined by algorithm module 296).

Block 3309 further includes optional block 33092 which provides for receiving an indication from the living entity and/or the representative of the living entity and/or the third party associated with the living entity, the indication including an informed consent prior to the enabling access of the one or more treatment plans and associated diagnosis (e.g., graphical user interface 214 receiving an input via user input/output device 260 including an indication from the living entity and/or the representative of the living entity including an informed consent prior to algorithm module 296 permitting a display of the one or more treatment plans and each associated diagnosis).

Further depicted within block 3309 is shown optional block 33094 which provides for enabling access to a cost-benefit analysis and/or a portion of the cost-benefit analysis associated with each treatment plan (e.g., display 240 and graphical user interface 214 operating to provide a cost-benefit analysis associated with the treatment plans).

Depicted within block 33094 are optional blocks 330941, 330942 and 330944. Block 339941 provides for enabling access to a risk-reward analysis and/or a portion of the risk-reward analysis associated with each treatment plan (e.g. graphical user interface 214 receiving risk-reward data or a portion of risk-reward data from network 220 or from data store 294 or database 290, and output module 298 operating to incorporate the risk-reward analysis data). Block 330942 provides for incorporating insurance coverage data into the cost-benefit analysis (e.g. graphical user interface 214 receiving data from network 220 or from data store 295 or database 290 to retrieve insurance coverage data, and output module 298 operating to incorporate the insurance coverage data), and block 330944 provides for incorporating life expectancy of the living entity into the cost-benefit analysis (e.g., graphical user interface 214 receiving data from network 220 or from data store 295 or database 290 to retrieve life expectance data of the living entity, and output module 298 operating to incorporate the life expectancy data into the cost-benefit analysis).

Those with skill in the computing arts will recognize that the disclosed embodiments have relevance to a wide variety of applications and architectures in addition to those described above. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation. Those having skill in the art will recognize that examples of such comprehensive devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc.); or (g) a wired/wireless services entity such as Sprint, Cingular, Nextel, etc.), etc.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

We claim:

1. A method for providing a medical diagnostic assistance, the method comprising:
receiving two or more health-related parameters of a living entity;
applying one or more algorithms to the two or more health-related parameters to generate one or more diagnostic possibilities with associated statistical likelihood; and
producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options.

2. (canceled)

3. The method of claim 1 wherein the receiving two or more health-related parameters of a living entity includes:
receiving statistical data related to the living entity wherein the statistical data includes past diagnostic possibility data.

4. The method of claim 1 wherein the receiving two or more health-related parameters of a living entity includes:
receiving the two or more health-related parameters including subjective criteria from one or more of the living entity and/or a representative of the living entity and/or a physician and/or an indirect source of subjective criteria.

5. The method of claim 1 wherein the receiving two or more health-related parameters of a living entity includes:
receiving the two or more health-related parameters specific to the living entity, the living entity being one of an animal, a plant, and/or a human entity.

6. (canceled)

7. (canceled)

8. (canceled)

9. (canceled)

10. (canceled)

11. (canceled)

12. (canceled)

13. The method of claim 1 wherein the applying one or more algorithms to the two or more health-related parameters to generate one or more diagnostic possibilities with associated statistical likelihood includes:
searching a database of symptom data and correlated diagnostic criteria;
comparing the symptom data and the correlated diagnostic criteria with the two or more health-related parameters to find a match; and
applying the algorithms to determine the one or more diagnostic possibilities and determine a likelihood of potential diagnoses.

14. (canceled)

15. The method of claim 1 wherein the producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
enabling access to the objective diagnostic options as a hierarchical display with one or more differential diagnoses.

16. The method of claim 1 wherein the producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
filtering the one or more diagnostic possibilities organized according to statistical likelihood to produce one or more treatment plans for each diagnostic possibility, each of the one or more treatment plans associated with a diagnosis; and
enabling access to the one or more treatment plans and associated diagnosis

17. The method of claim 16 wherein the enabling access to the one or more treatment plans and associated diagnosis includes:
receiving an indication from the living entity and/or the representative of the living entity and/or the third party associated with the living entity, the indication including one or more of an informed consent that enables access to one or more available tests associated with the one or more diagnostic possibilities, and/or an expression of understanding the one or more diagnostic possibilities, and/or an acceptance of the one or more available tests, and/or a declination of the one or more available tests, and/or an acceptance of one or more risks and/or one or more responsibilities associated with the one or more diagnostic possibilities.

18. The method of claim 16 wherein the enabling access to the one or more treatment plans and associated diagnosis includes:
receiving an indication from the living entity and/or the representative of the living entity and/or the third party associated with the living entity, the indication including an informed consent prior to the enabling access of the one or more treatment plans and associated diagnosis.

19. The method of claim 16 wherein the enabling access to the one or more treatment plans and associated diagnosis includes:
enabling access to a cost-benefit analysis and/or a portion of the cost-benefit analysis associated with each treatment plan.

20. The method of claim 19 wherein the enabling access to the one or more treatment plans and associated diagnosis includes:
enabling access to a risk-reward analysis and/or a portion of the risk-reward analysis associated with each treatment plan.

21. The method of claim 19 wherein the enabling access to a cost-benefit analysis and/or a portion of the cost-benefit analysis associated with each treatment plan includes:
incorporating insurance coverage data into the cost-benefit analysis.

22. The method of claim 19 wherein the enabling access to a cost-benefit analysis and/or a portion of the cost-benefit analysis associated with each treatment plan includes:
incorporating life expectancy of the living entity into the cost-benefit analysis.

23. The method of claim 16 wherein the filtering the one or more diagnostic possibilities organized according to statistical likelihood to produce one or more treatment plans for each diagnostic possibility, each of the one or more treatment plans associated with a diagnosis includes:
receiving an input from a healthcare provider, the input controlling presentation of the one or more diagnostic possibilities available for access by the living entity and/or the representative of the living entity and/or the third party associated with the living entity.

24. The method of claim 23 wherein the receiving an input from a healthcare provider, the input controlling presentation of the one or more diagnostic possibilities available for access by the living entity and/or the representative of the living entity and/or the third party associated with the living entity includes:
receiving the input from the healthcare provider to provide the limit on the number of the one or more diagnostic possibilities based on one or more of a predetermined statistical likelihood for the treatment plan for each diagnostic possibility, and/or a limit based on health-care provider determined elimination.

25. The method of claim 1 wherein the producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
receiving an input from a healthcare professional, the input providing a limit on the one or more objective diagnostic options available for access by the living entity and/or the representative of the living entity.

26. A computer program product comprising:
a signal bearing medium bearing at least one of:
one or more instructions for receiving two or more health-related parameters of a living entity;
one or more instructions for applying one or more algorithms to the two or more health-related parameters to generate one or more diagnostic possibilities with associated statistical likelihood; and
one or more instructions for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options.

27. The computer program product of claim 26 wherein the signal bearing medium comprises:
a recordable medium.

28. The computer program product of claim 26 wherein the signal bearing medium comprises:
a transmission medium.

29. (canceled)

30. (canceled)

31. (canceled)

32. (canceled)

33. The computer program product of claim 26 wherein the one or more instructions for receiving two or more health-related parameters of a living entity includes:
one or more instructions for receiving the two or more health-related parameters via a network connection to one or more sources of health-related data including one or more of insurance data sources, physician data sources, veterinary medicine data sources, online medical information sources, and hospital data sources.

34. The computer program product of claim 26 wherein the one or more instructions for applying one or more algorithms to the two or more health-related parameters to generate one or more diagnostic possibilities with associated statistical likelihood includes:
one or more instructions for applying the one or more algorithms to assess a likelihood for each of the one or more diagnostic possibilities, each of the one or more likelihoods being arranged systematically.

35. The computer program product of claim 34 wherein the one or more instructions for applying the one or more algorithm to assess a likelihood for each of the one or more diagnostic possibilities, each of the one or more likelihoods being arranged systematically includes:
one or more instructions for by prioritizing a most likely treatment option associated with the one or more diagnostic possibilities.

36. (canceled)

37. (canceled)

38. (canceled)

39. (canceled)

40. (canceled)

41. The computer program product of claim 26 where the one or more instructions for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
one or more instructions for producing the one or more objective diagnostic options via a graphical user interface capable of illustrating the objective diagnostic options and one or more derivative possibilities from among the one or more objective diagnostic options; and
one or more instructions for producing a prediction of risks, costs and/or benefits based on the one or more diagnostic options.

42. (canceled)

43. The computer program product of claim 26 wherein the one or more instructions for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes;
one or more instructions for filtering the one or more diagnostic possibilities organized according to statistical likelihood to produce one or more treatment plans for each diagnostic possibility, each of the one or more treatment plans associated with a diagnosis; and
one or more instructions for enabling access to the one or more treatment plans and associated diagnosis.

44. (canceled)

45. The computer program product of claim 43 wherein the one or more instructions for enabling access to the one or more treatment plans and associated diagnosis includes:
one or more instructions for receiving an indication from the living entity and/or the representative of the living entity and/or the third party associated with the living
entity, the indication including an informed consent prior to the enabling access of the one or more treatment plans and associated diagnosis.

46. The computer program product of claim 43 wherein the one or more instructions for enabling access to the one or more treatment plans and associated diagnosis includes:
one or more instructions for enabling access to a cost-benefit analysis and/or a portion of the cost-benefit analysis associated with each treatment plan.

47. (canceled)

48. (canceled)

49. (canceled)

50. (canceled)

51. (canceled)

52. The computer program product of claim 26 wherein the one or more instructions for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
one or more instructions receiving an input from a healthcare professional, the input providing a limit on the one or more objective diagnostic options available for access by the living entity and/or the representative of the living entity.

53. A physician tool for assisting objective diagnosis of a patient, the physician tool comprising:
a processor,
a memory coupled to the processor;
a database coupled to the processor, the database configured to store symptom data and diagnostic criteria correlated to the symptom data; and
a diagnostic module coupled to the processor, the diagnostic module configured to include:
an entry module for receiving two or more health-related parameters of a living entity,
an algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood, and
an output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options.

54. (canceled)

55. (canceled)

56. The physician tool of claim 53 wherein the entry module for receiving two or more health-related parameters of a living entity includes:
a data store configured for receiving one or more of symptom data, one or more physical status parameters, one or more recorded observations, one or more environmental parameters, laboratory data, and a health history specific to the living entity.

57. (canceled)

58. (canceled)

59. (canceled)

60. (canceled)

61. The physician tool of claim 53 wherein the algorithm module in communication with the entry module and the database, the algorithm module con to receive the symptom data and correlated diagnostic criteria and coded for applying one or more algorithms to the two or more health-related parameters to generate one or more diagnostic possibilities with associated statistical likelihood includes:
means for applying the one or more algorithms to assess a likelihood for each of the one or more diagnostic possibilities, each of the one or more likelihoods being arranged systematically.

62. (canceled)

63. The physician tool of claim 53 wherein the algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood includes:
means for arranging according to a severity level associated with the one or more treatment options.

64. The physician tool of claim 53 wherein the algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood includes:
means for applying a correlation algorithm to correlate one or more objective parameters of the health-related parameters with one or more subjective parameters of the health-related parameters.

65. The physician tool of claim 64 wherein the means for applying a correlation algorithm to correlate one or more objective parameters of the health-related parameters with one or more subjective parameters of the health-related parameters includes:
a comparator configured for comparing the health-related parameters to the one or more objective parameters via a database including symptom data and correlated diagnostic criteria.

66. The physician tool of claim 64 wherein the means for applying a correlation algorithm to correlate one or more objective parameters of the health-related parameters with one or more subjective parameters of the health-related parameters includes:
a comparator configured for comparing the health-related parameters to the one or more subjective parameters including one or more subjective perceptions received by the living entity and/or by a representative of the living entity and/or by a physician familiar with the living entity.

67. The physician tool of claim 53 wherein the algorithm module in communication with the entry module and the database, the algorithm module configured to receive the symptom data and correlated diagnostic criteria and configured for applying one or more algorithms to the two or more health-related parameters to generate one or more diagnostic possibilities with associated statistical likelihood includes:
a query module configured for searching a database of symptom data and correlated diagnostic criteria;
a comparator configured for comparing the symptom data and the correlated diagnostic criteria with the two or more health-related parameters to find a match; and
an application module configured for applying the algorithms to determine the one or more diagnostic possibilities and determine a likelihood of potential diagnoses.

68. The physician tool of claim 53 wherein the output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
a graphical user interface configured to produce one or more objective diagnostic options, the graphical user interface configured to illustrate the objective diagnostic options and one or more derivative possibilities from among the one or more objective diagnostic options.

69. The physician tool of claim 68 wherein the graphical user interface configured to produce one or more objective diagnostic options, the graphical user interface configured to illustrate the objective diagnostic options and one or more derivative possibilities from among the one or more objective diagnostic options includes:
means for enabling access of a prediction of costs and benefits based on the one or more diagnostic options.

70. The physician tool of claim 68 wherein the graphical user interface configured to produce one or more objective diagnostic options, the graphical user interface configured to illustrate the objective diagnostic options and one or more derivative possibilities from among the one or more objective diagnostic options includes:
means for enabling access to the objective diagnostic options as a hierarchical display with one or more differential diagnoses.

71. The physician tool of claim 53 wherein the output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
a filter configured for filtering the one or more diagnostic possibilities organized according to statistical likelihood to produce one or more treatment plans for each diagnostic possibility, each of the one or more treatment plans associated with a diagnosis; and
a graphical user interface coupled to the filter, the graphical user interface configured for enabling access to the one or more treatment plans and associated diagnosis.

72. (canceled)

73. The physician tool of claim 72 wherein the graphical user interface configured for receiving an input from a healthcare provider, the input controlling presentation of the one or more diagnostic possibilities available for access by the living entity and/or the representative of the living entity and/or the third party associated with the living entity is further configured for receiving the input from the healthcare provider to provide the limit on the number of the one or more diagnostic possibilities based on one or more of a predetermined statistical likelihood for the treatment plan for each diagnostic possibility, and/or a limit based on health-care provider determined elimination.

74. The physician tool of claim 53 wherein the output module coupled to the processor, the output module configured for producing one or more objective diagnostic options based on the one or more diagnostic possibilities, the one or more objective diagnostic options organized to enable the living entity and/or a representative of the living entity and/or a third party associated with the living entity to make an informed decision from the one or more objective diagnostic options includes:
a filter coupled to the processor, the filter configured for receiving an input from a healthcare professional, the input providing a limit on the one or more objective diagnostic options available for access by the living entity and/or the representative of the living entity.

75. The physician tool of claim 71 wherein the graphical user interface coupled to the filter, the graphical user interface configured for enabling access to the one or more treatment plans and associated diagnosis is further configured for receiving an input from a healthcare professional, the input providing a limit on the one or more objective diagnostic options available for access by the living entity and/or the representative of the living entity.

76. (canceled)

77. The physician tool of claim 71 wherein the graphical user interface coupled to the filter, the graphical user interface configured for enabling access to the one or more treatment plans and associated diagnosis is further configured for incorporating life expectancy of the living entity into the cost-benefit analysis.

78. (canceled)
